(19) United States
(12) Patent Application Publication
(10) Pub. No.: US 2026/0222449 A1
(43) Pub. Date: Jul. 30, 2026

(54) Scenario-based Cyber Network Topology Generation System and Method

(71) Applicant: IDS TECHNOLOGY LLC, Arlington, VA (US)

(72) Inventors: Noah Melgar, Islamorada, FL (US); Jefferson David Hoye, Arlington, VA (US); Tung Tran, Bradenton, FL (US)

(21) Appl. No.: 19/453,836

(22) Filed: Jan. 20, 2026

Related U.S. Application Data
(60) Provisional application No. 63/746,404, filed on Jan. 17, 2025.

(51) Int. Cl. H04L 9/40; G06N 20/00

(52) U.S. Cl. CPC H04L 63/20; G06N 20/00

(57) ABSTRACT

An AI-based energy edge platform is provided herein with a wide range of features, components and capabilities for management and improvement of legacy infrastructure, coordination, and orchestration with distributed systems to support important use cases for a range of enterprises. An AI-based energy edge platform may include a graph neural network including a set of nodes respectively representing at least one distributed energy resource (DER) and a set of edges respectively interconnecting the set of nodes, wherein each edge represents at least one energy-related feature among at least two nodes of the set of nodes. The platform may incorporate emerging technologies to enable ecosystem and individual energy edge node efficiencies, agility, engagement, and profitability. Embodiments may forecast, plan for, and manage the demand and utilization of energy in greater distributed environments. Embodiments may employ intelligent provisioning, data aggregation, and analytics to leverage energy market connection, communication, and transaction enablement platforms.

### RELATED CASES

This application claims the benefit of U.S. Provisional Application No. 63/746,404, filed on 17 Jan. 2025, the contents of which are all incorporated by reference.

### BACKGROUND

Modernly, individuals, corporations, and governments are critically dependent on interconnected computer systems and digital networks, such as the Internet, for a vast array of functions. These systems are used to store, process, and transmit immense quantities of sensitive information, including personal identifying information (PII), financial records, proprietary trade secrets, and classified government data. The seamless operation of critical infrastructure, including power grids, financial markets, and transportation systems, also relies heavily on the integrity and availability of these digital systems.

To protect these vital assets, the field of cybersecurity has emerged. Conventional cybersecurity approaches employ a variety of tools and methodologies. These include perimeter defenses like firewalls, which are designed to control incoming and outgoing network traffic based on predetermined security rules. Antivirus and anti-malware software are widely deployed on endpoint devices to detect and quarantine malicious code based on known signatures. Intrusion Detection Systems (IDS) and Intrusion Prevention Systems (IPS) are used to monitor network or system activities for malicious patterns and to block or report such activities. Furthermore, encryption is commonly used to render data unreadable to unauthorized parties, both when it is at rest (stored) and in transit (being transmitted). Access control mechanisms, such as passwords, multi-factor authentication, and biometrics, are employed to verify the identity of users before granting access to systems and data.

However, these conventional security measures suffer from significant and growing limitations. The threat landscape is not static; it is a dynamic environment in which malicious actors continuously devise new and more sophisticated attack vectors. These include zero-day exploits, which target previously unknown vulnerabilities in software, and advanced persistent threats (APTs), where attackers gain an undetected foothold in a network to exfiltrate data over an extended period.

Many traditional security systems are fundamentally reactive. For instance, signature-based antivirus software is ineffective against novel malware for which no signature yet exists. This creates a critical window of vulnerability between the time a new threat is released and the time a defense is developed and deployed.

Moreover, the increasing complexity of modern information technology (IT) environments, which often include a mix of on-premises servers, cloud services, and a proliferation of Internet of Things (IoT) devices, has exponentially expanded the potential “attack surface.” Securing this vast and distributed surface area with traditional, perimeter-focused tools is exceedingly difficult. Finally, the human element remains a persistent vulnerability, as social engineering techniques like phishing can often bypass even robust technological defenses by deceiving legitimate users into compromising security.

A failure in cybersecurity can have catastrophic consequences, ranging from significant financial losses and reputational harm to the disruption of essential services and threats to national security. Therefore, there exists a substantial and ongoing need in the art for improved cybersecurity systems and methods that can proactively and intelligently identify, analyze, and neutralize novel and sophisticated threats in real-time across complex and heterogeneous computing environments.

### BRIEF SUMMARY OF DISCLOSURE

In one example implementation, a method, performed by one or more computing devices, may include but is not limited to processing, using a machine learning model, an input description of a target virtual network topology. A plurality of network topology parameters are generated using the input description by processing, on the machine learning model, a plurality of prompts defining the plurality of network topology parameters from the input description. A plurality of network nodes are generated, using the machine learning model, from a plurality of network schemas. A virtual network configuration file is generated based upon, at least in part, the input description, the plurality of network topology parameters, and the plurality of network nodes.

One or more of the following example features may be included. The machine learning model may be a multimodal machine learning model. The input description may include one or more of a text-based description and an image-based description of the target virtual network topology. The plurality of network topology parameters include one or more of: entity size information; network infrastructure information; and network device information. The plurality of network schemas may include one or more of: a first JSON schema defining network-wide characteristics; a second JSON schema defining network nodes with child relationships; and a third JSON schema defining terminal device specifications. Generating the virtual network configuration file may include: mapping the plurality of network topology parameters to respective network nodes from the plurality of network nodes; and generating a hierarchical network topology using the plurality of network nodes. A simulation of a virtual network may be executed using the virtual network configuration file.

In another example implementation, a computing system may include one or more processors and one or more memories configured to process, using a machine learning model, an input description of a target virtual network topology. A plurality of network topology parameters are generated using the input description by processing, on the machine learning model, a plurality of prompts defining the plurality of network topology parameters from the input description. A plurality of network nodes are generated, using the machine learning model, from a plurality of network schemas. A virtual network configuration file is generated based upon, at least in part, the input description, the plurality of network topology parameters, and the plurality of network nodes.

One or more of the following example features may be included. The machine learning model may be a multimodal machine learning model. The input description may include one or more of a text-based description and an image-based description of the target virtual network topology. The plurality of network topology parameters include one or more of: entity size information; network infrastructure information; and network device information. The plurality of network schemas may include one or more of: a first JSON schema defining network-wide characteristics; a second JSON schema defining network nodes with child relationships; and a third JSON schema defining terminal device specifications. Generating the virtual network configuration file may include: mapping the plurality of network topology parameters to respective network nodes from the plurality of network nodes; and generating a hierarchical network topology using the plurality of network nodes. A simulation of a virtual network may be executed using the virtual network configuration file.

In another example implementation, a computer program product may reside on a computer readable storage medium having a plurality of instructions stored thereon which, when executed across one or more processors, may cause at least a portion of the one or more processors to perform operations that may include but are not limited to processing, using a machine learning model, an input description of a target virtual network topology. A plurality of network topology parameters are generated using the input description by processing, on the machine learning model, a plurality of prompts defining the plurality of network topology parameters from the input description. A plurality of network nodes are generated, using the machine learning model, from a plurality of network schemas. A virtual network configuration file is generated based upon, at least in part, the input description, the plurality of network topology parameters, and the plurality of network nodes.

One or more of the following example features may be included. The machine learning model may be a multimodal machine learning model. The input description may include one or more of a text-based description and an image-based description of the target virtual network topology. The plurality of network topology parameters include one or more of: entity size information; network infrastructure information; and network device information. The plurality of network schemas may include one or more of: a first JSON schema defining network-wide characteristics; a second JSON schema defining network nodes with child relationships; and a third JSON schema defining terminal device specifications. Generating the virtual network configuration file may include: mapping the plurality of network topology parameters to respective network nodes from the plurality of network nodes; and generating a hierarchical network topology using the plurality of network nodes. A simulation of a virtual network may be executed using the virtual network configuration file.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a network topology generation process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a network topology generation process according to one or more example implementations of the disclosure;

FIG. 4 is an example diagrammatic view of the processing of an input description for a target virtual network topology according to one or more example implementations of the disclosure;

FIG. 5 is an example diagrammatic view of the generation of network topology parameters from a plurality of prompts and the input description according to one or more example implementations of the disclosure;

FIG. 6 is an example diagrammatic view of the generation of a network configuration file according to one or more example implementations of the disclosure; and

FIG. 7 is an example diagrammatic view of the simulation of a virtual network according to one or more example implementations of the disclosure.

Like reference symbols in the various drawings may indicate like elements.

### DETAILED DESCRIPTION

### System Overview

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electromagnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN), a wide area network (WAN), a body area network BAN), a personal area network (PAN), a metropolitan area network (MAN), etc., or the connection may be made to an external computer (for example, through the internet using an Internet Service Provider). In some implementations, electronic circuitry including, for example, programmable logic circuitry, an application specific integrated circuit (ASIC), field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

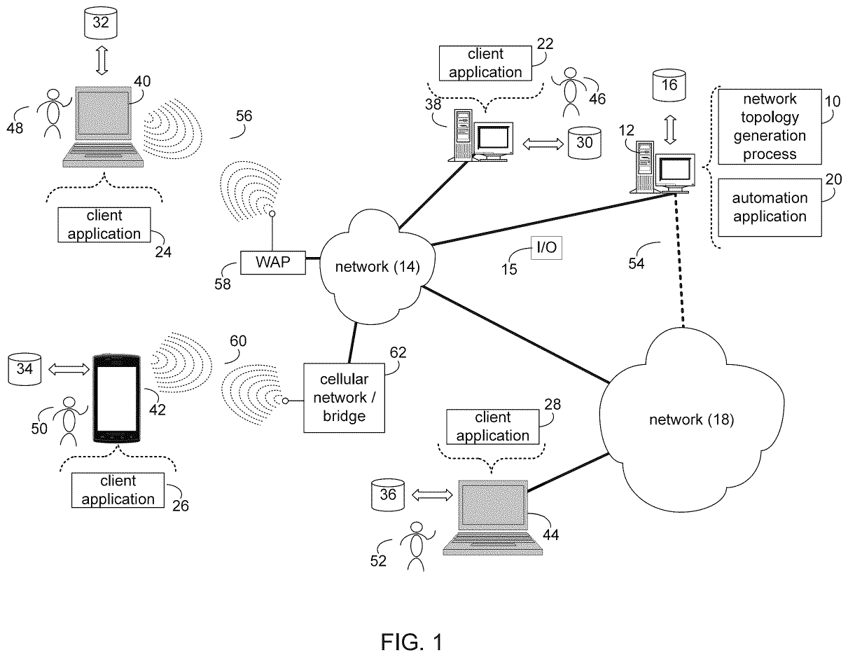

Referring now to the example implementation of FIG. 1, there is shown network topology generation process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a network topology generation process, such as network topology generation process 10 of FIG. 1, may process, using a machine learning model, an input description of a target virtual network topology. A plurality of network topology parameters are generated using the input description by processing, on the machine learning model, a plurality of prompts defining the plurality of network topology parameters from the input description. A plurality of network nodes are generated, using the machine learning model, from a plurality of network schemas. A virtual network configuration file is generated based upon, at least in part, the input description, the plurality of network topology parameters, and the plurality of network nodes.

In some implementations, the instruction sets and subroutines of network topology generation process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, network topology generation process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute an automation application (e.g., automation application 20), examples of which may include, but are not limited to, e.g., a network simulation application, a network infrastructure management application, cyber security applications, or other application that allows the generation and management of cyber devices, networks, network infrastructure, and/or virtual networks. In some implementations, network topology generation process 10 and/or automation application 20 may be accessed via one or more of client applications 22, 24, 26, 28. In some implementations, network topology generation process 10 may be a standalone application, or may be an applet/application/script/extension that may interact with and/or be executed within automation application 20, a component of automation application 20, and/or one or more of client applications 22, 24, 26, 28. In some implementations, automation application 20 may be a standalone application, or may be an applet/application/script/extension that may interact with and/or be executed within network topology generation process 10, a component of network topology generation process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of network topology generation process 10 and/or automation application 20. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone (such as those embedded within eyeglasses, smart phones, tablet computers and/or watches, etc.), and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of network topology generation process 10 (and vice versa). Accordingly, in some implementations, network topology generation process 10 may be a purely server-side application, a purely client-side application, or a hybrid server-side/client-side application that is cooperatively executed by one or more of client applications 22, 24, 26, 28 and/or network topology generation process 10.

In some implementations, one or more of client applications 22, 24, 26, 28 may be configured to effectuate some or all of the functionality of automation application 20 (and vice versa). Accordingly, in some implementations, automation application 20 may be a purely server-side application, a purely client-side application, or a hybrid server-side/client-side application that is cooperatively executed by one or more of client applications 22, 24, 26, 28 and/or automation application 20. As one or more of client applications 22, 24, 26, 28, network topology generation process 10, and automation application 20, taken singly or in any combination, may effectuate some or all of the same functionality, any description of effectuating such functionality via one or more of client applications 22, 24, 26, 28, network topology generation process 10, automation application 20, or combination thereof, and any described interaction(s) between one or more of client applications 22, 24, 26, 28, network topology generation process 10, automation application 20, or combination thereof to effectuate such functionality, should be taken as an example only and not to limit the scope of the disclosure.

In some implementations, one or more of users 46, 48, 50, 52 may access computer 12 and network topology generation process 10 (e.g., using one or more of client electronic devices 38, 40, 42, 44) directly through network 14 or through secondary network 18. Further, computer 12 may be connected to network 14 through secondary network 18, as illustrated with phantom link line 54. Network topology generation process 10 may include one or more user interfaces, such as browsers and textual or graphical user interfaces, through which users 46, 48, 50, 52 may access network topology generation process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11 g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12 (and vice versa). Examples of I/O request 15 may include but are not limited to, data write requests (e.g., a request that content be written to computer 12) and data read requests (e.g., a request that content be read from computer 12).

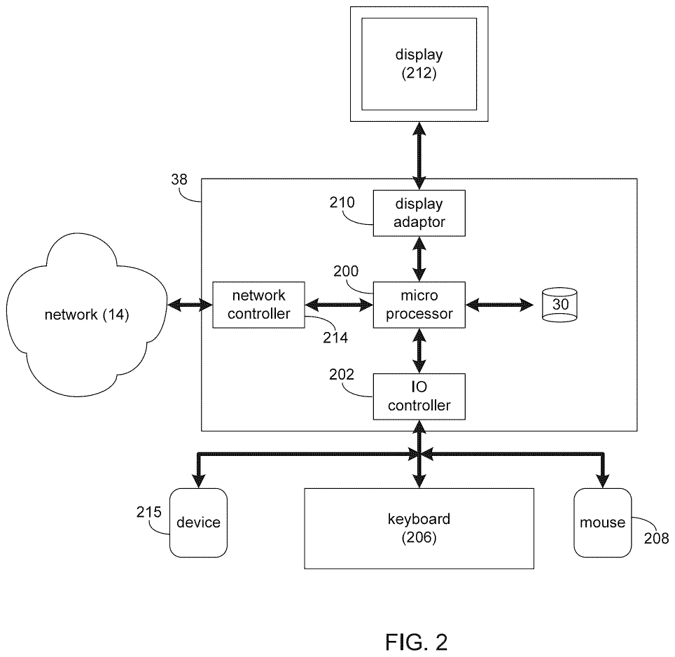

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, network topology generation process 10 may be substituted for client electronic device 38 (in whole or in part) within FIG. 2, examples of which may include but are not limited to computer 12 and/or one or more of client electronic devices 38, 40, 42, 44.

In some implementations, client electronic device 38 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 30). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

### The Network Topology Generation Process:

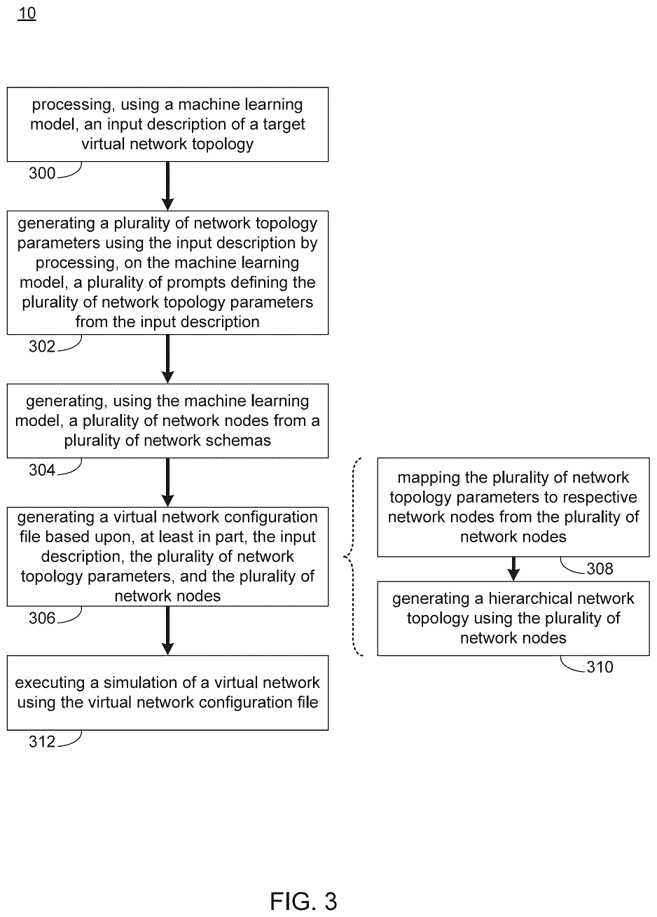

As discussed above and referring also at least to the example implementations of FIGS. 3-7, network topology generation process 10 may process 300, using a machine learning model, an input description of a target virtual network topology. A plurality of network topology parameters are generated 302 using the input description by processing, on the machine learning model, a plurality of prompts defining the plurality of network topology parameters from the input description. A plurality of network nodes are generated 304, using the machine learning model, from a plurality of network schemas. A virtual network configuration file is generated 306 based upon, at least in part, the input description, the plurality of network topology parameters, and the plurality of network nodes.

Implementations of the present disclosure generate synthetic virtual networks resembling real-world topologies. For example and as will be described in greater detail below, users may provide a contextual scenario as input (e.g., “a local credit union” or “a regional airport”), from which a virtual network topology is derived. Network topology generation process 10 fundamentally differs from traditional network topology generators that require users to manually specify network parameters, device counts, and connection patterns. Instead, by providing only a brief contextual description, network topology generation process 10 applies its world knowledge to infer realistic organizational structures, personnel counts, device requirements, and network characteristics appropriate for that context. The model then processes this information through a two-action pipeline: “brainstorming” and “formalization” that enhances a machine learning model to generate a virtual network topology.

During the “brainstorming”, a machine learning model is configured by network topology generation process 10 to process the scenario's organizational structure, personnel, devices, and network characteristics, producing a high-level outline in natural language. This leverages the machine learning model's broad knowledge of how different types of organizations are structured—from the hierarchical departments in a regional airport to the specialized operational units on a deep-sea oil rig. During “formalization”, network topology generation process 10 transforms the representation of the virtual network topology into an executable virtual network configuration file in a machine-readable format. The machine learning model generates the network topology in a top-down fashion, starting from a designated root node and recursively creating subtrees and child nodes. By using structured outputs constrained by a network schema (e.g., various JSON schemas), network topology generation process 10 ensures that all intermediate nodes strictly conform to a predefined schema, guaranteeing valid and consistent network representations. These nodes are coalesced into a single virtual network configuration file (e.g., a JSON file) representing the complete network topology that is used to generate a simulation of the virtual network.

### Brainstorming:

In some implementations, network topology generation process 10 may process 300, using a machine learning model, an input description of a target virtual network topology. For example, in an initial phase of “brainstorming”, network topology generation process 10 may allow a user to provide an input description of a context (e.g., “a regional airport”, “a local credit union,” “a deep-sea oil rig”, or “a commercial data center”) for a target virtual network topology. A target virtual network topology is a virtual representation of a physical network that includes virtual representations of the physical components of a network. In some implementations, only a minimal input (e.g., a limited description of the target virtual network topology) is processed into the target virtual network topology by leveraging a machine learning model to exercise its knowledge and training data to derive a plausible organizational structure without requiring users to have domain expertise in network design.

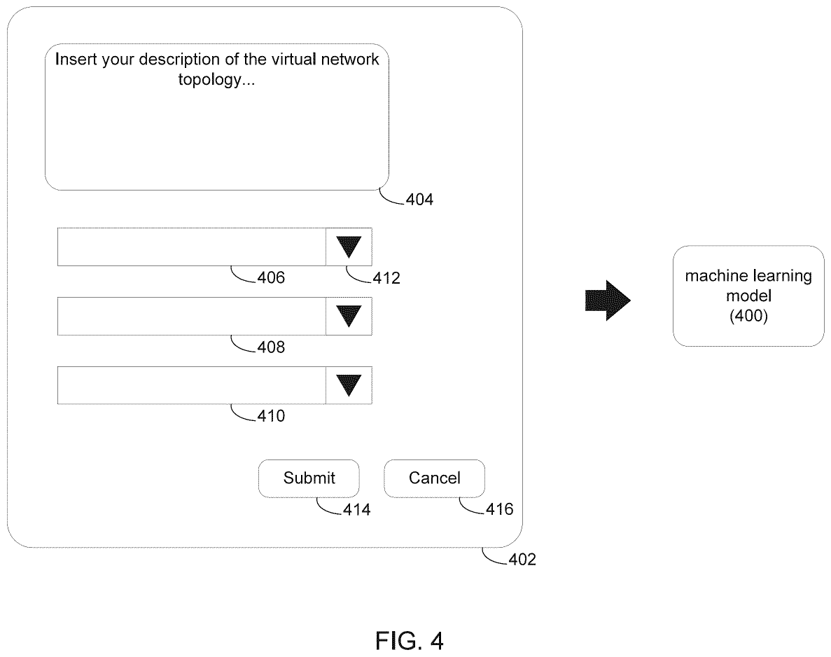

In some implementations and referring also to FIG. 4, a machine learning model (e.g., machine learning model 400) is trained to generate virtual network topologies. To provide context for machine learning model 400, a general overview of the principles of machine learning is presented, followed by a description of how these principles apply to the specific task of network topology generation.

Machine learning is a subfield of artificial intelligence wherein a computer system is not explicitly programmed to perform a task but instead “learns” to do so by identifying patterns and relationships within data. The core of a machine learning system is the “model,” (e.g., machine learning model 400) which is a computational construct, often a complex mathematical function with numerous internal parameters (frequently referred to as “weights” and “biases”). In many modern applications, machine learning model 400 takes the form of an artificial neural network, which is a system of interconnected nodes inspired by the structure of a biological brain.

The process by which machine learning model 400 learns is called “training”. During training, machine learning model 400 is exposed to a large dataset, known as the “training data”. In the context of the present disclosure, this training data may comprise a vast and diverse collection of pre-existing network topologies. These example topologies can be sourced from real-world enterprise networks, data centers, or synthetically generated but valid configurations. Each topology in the dataset is represented in a machine-readable format, such as a graph structure defined by nodes, edges, and their associated properties (e.g., device type, link bandwidth).

The training process is an iterative optimization procedure. For each example in the training data, machine learning model 400 attempts to generate an output. An “objective function”, also known as a “loss function”, is used to measure the discrepancy between machine learning model 400's output and the desired outcome. This function quantifies the model's error. For a generative task like creating network topologies, the objective function may measure how closely the statistical properties of the generated topology match the properties of the real topologies in the training set, or it might assess the structural validity and adherence to fundamental networking principles.

An optimization algorithm, such as gradient descent, is then used to adjust the model's internal parameters in a direction that minimizes the error calculated by the loss function. This process is repeated thousands or millions of times, with the model processing the training data iteratively. With each iteration, machine learning model 400's parameters are refined, and machine learning model 400 becomes progressively better at its task—in this case, generating outputs that are structurally and statistically similar to the valid network topologies it has been trained on.

Once the training process is complete, the machine learning model 400's parameters are fixed, and it is ready for the “inference” or “generation” phase. In this phase, the trained model can be used to generate novel network topologies that have not been seen before. Machine learning model 400 can be provided with an input, which may be a set of high-level constraints or requirements (e.g., a desired number of routers and switches, a specific redundancy level, target latency characteristics) or a random seed vector. Based on this input, machine learning model 400 applies its learned patterns to produce a complete, new virtual network topology as its output. This output is a data structure that defines all the necessary components-virtual devices, their configurations, and their interconnections-which can then be instantiated in a network emulation platform for testing and analysis.

By leveraging this machine learning approach, network topology generation process 10 automates the complex, time-consuming, and error-prone manual process of designing test topologies. Network topology generation process 10 allows for the rapid generation of a wide variety of realistic and complex network scenarios, enabling more comprehensive and robust validation of network hardware, software, and configurations than is possible with conventional methods.

In some implementations, the machine learning model may be a multimodal machine learning model. For example, machine learning model 400 may be implemented as a large language model (LLM) with multimodal capabilities. This approach enables network topology generation process 10 to interpret and synthesize information from multiple, disparate input formats or “modalities”. For instance, a user can provide a high-level goal in natural language text, such as “Generate a secure corporate network for 500 users with a separate guest Wi-Fi segment and redundant internet connections.” Concurrently, the user might provide a simplified architectural diagram as an image file, or a partial configuration snippet in a structured data format like YAML. The multimodal model (e.g., machine learning model 400) may be trained to process these varied inputs simultaneously. The LLM component excels at understanding the semantic meaning, constraints, and intent within the natural language query, while other components of machine learning model 400 are trained to parse the visual structure of the diagram and the syntax of the configuration data. By learning the correlations between these modalities—for example, how the textual phrase “redundant internet connections” corresponds to a diagrammatic representation of two routers connecting to distinct external networks machine learning model 400 builds a holistic understanding of the user's requirements. From this integrated understanding and as will be described in greater detail below, machine learning model 400 generates a virtual network topology, outputting it as a fully-specified, machine-readable data structure ready for instantiation in a simulation environment.

In some implementations, the input description includes one or more of a text-based description and an image-based description of the target virtual network topology. For example and referring again to FIG. 4, network topology generation process 10 may provide a user interface (e.g., graphical user interface 402) to a user for receiving an input description for the target virtual network topology. In the example of FIG. 4, graphical user interface 402 may include various windows for receiving the input description for the target virtual network topology (e.g., windows 404, 406, 408, 410). In this example, window 404 may be an unbounded content window for receiving any type of input (e.g., text-based description written into window 404, image-based description drawn by a user within window 404, text-based description as a file that is dragged and dropped into window 404, and/or image-based description from a file that is dragged and dropped into window 404). In another example, network topology generation process 10 may process an audio-based description of the target virtual network topology by processing audio input from a user and processing the audio directly using machine learning model 400 and/or by generating a representation of the audio from the user for representation-based processing. In one example, network topology generation process 10 generates a transcription of the audio and processes the transcription as the input description of the target virtual network topology.

In the example of FIG. 4, windows 406, 408, 410 may include drop-down menus or lists selectable by a user for specifying attributes of the target virtual network topology from various predefined or dynamically-generated menus or lists. In one example, window 406 may include a graphical element (e.g., graphical element 412) for expanding a menu or list of options that are selectable for various attributes of the target virtual network topology. In one example, window 406 may concern entity size; window 408 may concern a number of users or network device; and window 410 may concern various types of networking infrastructure available for the target virtual network topology. In the example of FIG. 4, a user may be provided with various options or buttons (e.g., buttons 414, 416) to instruct machine learning model 400 to process their input description. While various examples of windows and other user interface elements have been described in FIG. 4, it will be appreciated that these are for example purposes only and that network topology generation process 10 may process 300 an input description for the target virtual network topology on a machine learning model in a variety of ways within the scope of the present disclosure.

In some implementations, network topology generation process 10 may generate 302 a plurality of network topology parameters using the input description by processing, on the machine learning model, a plurality of prompts defining the plurality of network topology parameters from the input description. A network topology parameter may generally include a fundamental attribute associated with the network topology that defines many characteristics for the target virtual network topology. For example, the plurality of network topology parameters may include one or more of entity size information; network infrastructure information; and network device information. As will be discussed in greater detail below, these features may provide the most representative elements for defining a target virtual network topology.

In some implementations, network topology generation process 10 may generate 302 the plurality of network topology parameters by processing a plurality of prompts or prompt sets associated with each network topology parameter. For example, two key techniques enable consistent, high-quality results across the initial “brainstorming” phase. The first is the concept of Chain of Thought (COT) reasoning (i.e., the sequential prompt chain implements a structured chain of thought) where machine learning model 400 explicitly processes through intermediate steps before arriving at a final answer. Rather than instructing machine learning model 400 to generate a complete network topology in a single step (which would produce inconsistent or incomplete results), each prompt or prompt set elicits a specific type of reasoning: organizational analysis, then infrastructure requirements, then device enumeration, then naming and structuring. This decomposition forces machine learning model 400 to “show its work”, and because conversation history is preserved, each subsequent step has access to machine learning model 400's prior reasoning. The explicit intermediate outputs in terms of network topology parameters (e.g., organizational hierarchy, infrastructure requirements, device counts) serve as scaffolding that guides the final outline generation, substantially improving coherence and completeness compared to single-shot generation.

The second concept is “conversation priming” using worked examples. For example and in some implementations, before processing user input, machine learning model 400 receives a prompt or prompt set containing detailed instructions and worked examples for each action of network topology generation process 10. These examples demonstrate the expected output format, level of detail, and reasoning patterns for representative contexts (e.g., a data center, an oil rig, an airport). This technique-sometimes called few-shot prompting-establishes consistent formatting conventions, appropriate granularity for personnel counts and device inventories, and domain-appropriate vocabulary. The worked examples also implicitly teach machine learning model 400 how different context types map to different organizational structures and network requirements, enabling generalization to novel contexts not explicitly covered in the examples.

In some implementations, network topology generation process 10 generates 302 a network topology parameter concerning entity size information. For example, machine learning model 400 first estimates the overall size of the entity and identifies all sites and their departments, specifying the number of personnel in each role. To help machine learning model 400 to reason systematically, network topology generation process 10 provides a hierarchical framework based on sites, departments, and other hierarchical or organizational structures within an entity. In one example, a “site” represents a physical location (e.g., a building, campus, or offshore platform), while a “department” may be a functional unit within a site (e.g., IT, Security, Operations). This hierarchy provides an intuitive reference structure that machine learning model 400 can apply to any context. Machine learning model 400 may classify organizations into size categories ranging from “tiny” (e.g., one site, with one-to-two departments) through “small” (e.g., one site with three-to-ten departments), “medium” (e.g., one site with over ten departments), “large” (e.g., one-to-three sites), “very large” (e.g., three-to-ten sites), to “extremely large” (e.g., ten or more sites). For example, a small retailer would be categorized as “tiny” with a single site and one-to-two departments, while a regional airport would be “large” with multiple sites (e.g., Airport Operations, individual airlines, and TSA), each containing their own departmental structure. The output is a structured breakdown of personnel counts by role for each department.

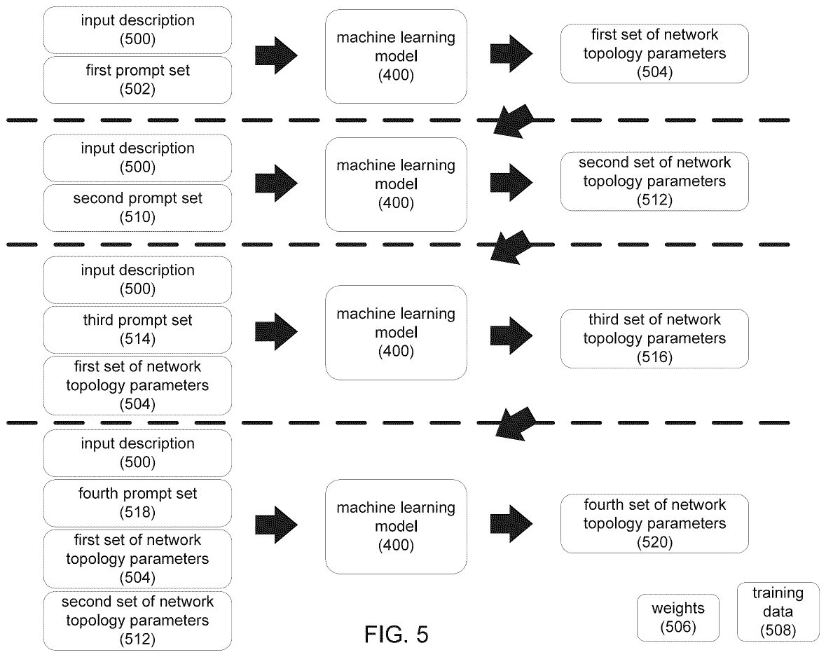

Referring also to the example of FIG. 5, network topology generation process 10 may process an input description (e.g., input description 500) and a first prompt set (e.g., first prompt set 502) associated with a first network topology parameter (e.g., entity size information). In this example, network topology generation process 10 generates 302 first set of network topology parameters 504 concerning entity size information by processing input description 500 and first prompt set 502 using machine learning model 400. In some implementations, machine learning model 400 may include bespoke weights (e.g., weights 506) and/or training data (e.g., training data 508) for first set of network topology parameters 504.

An example of first prompt set 502 and first set of network topology parameters 504 is shown below in Table 1:

TABLE 1

| First Prompt Set 502 | First Set of Network Topology Parameters 504 |
|---|---|
| The context is: *{context}*. | The commercial data center operates a single |
| Start by estimating the overall | primary data center site, structured into seven major |
| size of the organization and | departments and staffed by approximately 60 |
| identify all sites and their | personnel. This is expected to be a *Large*-sized |
| departments, specifying the | network. |
| number of personnel in each role. | #### Data Center Site |
| Clearly state the total number | 1. **Data Center Operations Department:** 18 |
| of sites, the expected network | people |
| size category, and provide a | Shift Operations Supervisors: 4 |
| detailed, structured breakdown | Data Center Technicians: 10 |
| for each site. For each | NOC Technicians: 4 |
| department, list the number of | 2. **Network Engineering Department:** 8 people |
| people and their roles. | Senior Network Engineers: 3 |
| | Junior Network Engineers: 5 |
| | 3. **Security Department:** 10 people |
| | Security Officers: 6 |
| | Security Supervisor: 1 |
| | Access Control: 2 |
| | Security Systems Administrator: 1 |

In some implementations, network topology generation process 10 generates 302 a network topology parameter concerning network infrastructure information. For example, machine learning model 400 identifies key network nodes and services required for the given context, considering fault tolerance, security, and redundancy measures. This network topology parameter evaluates six categories of network requirements: (1) Network Infrastructure & Traffic Management (DNS, load balancing, VPN, firewalls); (2) Application & Web Services (web hosting, email, VoIP); (3) Identity & Access Management (authentication services); (4) Data Storage & Management (NAS, databases, backup systems); (5) IoT & Automation (smart devices, building automation); and (6) Security Monitoring & Analysis (SIEM systems). In some implementations, network topology generation process 10 generates 302 a network topology parameter concerning network infrastructure information because the organizational structure of first network topology parameter 504 alone may not determine topology size-a data center requires substantially more IT infrastructure than a car dealership of similar headcount because its core function is IT service delivery. By considering both the organizational structure of first set of network topology parameters 504 and the technical requirements identified in the second set of network topology parameters, machine learning model 400 produces network designs appropriate for the context's operational needs.

Referring again to the example of FIG. 5, network topology generation process 10 may process an input description (e.g., input description 500), a second prompt set (e.g., second prompt set 510) associated with a second network topology parameter (e.g., network infrastructure information), and first set of network topology parameters 504. In this example, network topology generation process 10 generates 302 second set of network topology parameters 512 concerning network infrastructure information by processing input description 500, second prompt set 510, and first set of network topology parameters 504 using machine learning model 400. In some implementations, machine learning model 400 may include bespoke weights (e.g., weights 506) and/or training data (e.g., training data 508) for second set of network topology parameters 512.

An example of second prompt set 510 and second set of network topology parameters 512 is shown below in Table 2:

TABLE 2

| Second Prompt Set 510 | Second Set of Network Topology Parameters 512 |
|---|---|
| Next, identify the key | 1. **Network Infrastructure & Traffic Management** |
| network nodes and services | **Domain Name Resolution**: Multiple internal |
| required for the given | DNS servers, at least two, deployed in failover clusters |
| context. | for high availability. |
| For each, consider the | **Firewall & Perimeter Security**: Multiple high- |
| necessary fault tolerance, | availability firewall pairs at network edges, active-active |
| security, and redundancy | or active-passive clusters. |
| measures to ensure reliable | 2. **Identity & Access Management** |
| and secure operations. | **Authentication Services**: Dual-redundant Active |
| | Directory domain controllers supporting staff and |
| | customer logins with MFA integration. |

In some implementations, network topology generation process 10 generates 302 a network topology parameter concerning network device information. For example, based on the personnel counts from first set of network topology parameters 504 and the infrastructure requirements from second set of network topology parameters 512, machine learning model 400 generates a department-by-department list of all devices, specifying device types, quantities, and intended users or functions. This includes end-user devices (desktops, laptops, tablets, phones), departmental equipment (printers, scanners, conferencing systems), and infrastructure devices (servers, switches, security appliances). Machine learning model 400 applies domain knowledge to assign appropriate devices—for example, drill operators on an oil rig receive ruggedized workstations rather than standard desktops, while a data center's NOC technicians require specialized monitoring consoles. Devices external to the physical premises (such as cloud services) are excluded, as the goal is to model the on-premises network topology.

Referring again to the example of FIG. 5, network topology generation process 10 may process an input description (e.g., input description 500), a third prompt set (e.g., third prompt set 514) associated with a third network topology parameter (e.g., network device information), first set of network topology parameters 504, and second set of network topology parameters 512. In this example, network topology generation process 10 generates 302 third set of network topology parameters 516 concerning network device information by processing input description 500, third prompt set 514, first set of network topology parameters 504, and second set of network topology parameters 512 using machine learning model 400. In some implementations, machine learning model 400 may include bespoke weights (e.g., weights 506) and/or training data (e.g., training data 508) for third set of network topology parameters 516.

An example of third prompt set 514 and third set of network topology parameters 516 is shown below in Table 3:

TABLE 3

| Third Prompt Set 514 | Third Set of Network Topology Parameters 516 |
|---|---|
| Next, generate a detailed, | ### Data Center Site |
| department-by-department | 1. **Data Center Operations Department:** 19 devices |
| list of all devices that will | Routers: 1 |
| exist within the context. | Desktop devices: 14 |
| For each department, | Specialized Monitoring Consoles: 4 |
| specify device types, | 2. **Network Engineering Department:** 11 devices |
| quantities, and intended | Desktop devices: 8 |
| users or functions. | Switches: 1 |
| | Routers: 2 |

In some implementations and in response to processing the plurality of prompts, network topology generation process 10 processes a final set of prompts, machine learning model 400 generates a hierarchical list of named nodes with plausible hostnames, following a consistent hierarchy. For example, suppose network topology generation process 10 determines the following hierarchical structure for the target virtual network topology based on the input description: Enterprise (for multi-site organizations)→Site→Department. In this example, the final set of prompts may define requirements for each hierarchical level. In one example, network topology generation process 10 may determine that each Enterprise and Site must have a router as its first device (representing the network gateway at that level), and each Department must have a switch as its first device (providing local connectivity). In some implementations, network topology generation process 10, using machine learning model 400 and the final set of prompts, uses a structured markdown format with clear device naming conventions (e.g., desktop-admin1, voip-phone-security[1-5], switch-it-dept). As will be discussed in greater detail below, this detailed outline becomes the input for the formalization step.

Referring again to the example of FIG. 5, network topology generation process 10 may process an input description (e.g., input description 500), a fourth prompt set (e.g., fourth prompt set 518) associated with a fourth network topology parameter, first set of network topology parameters 504, second set of network topology parameters 512, and third set of network topology parameters 516. In this example, network topology generation process 10 generates 302 fourth set of network topology parameters 520 by processing input description 500, fourth prompt set 518, first set of network topology parameters 504, and second set of network topology parameters 512 using machine learning model 400. In some implementations, machine learning model 400 may include bespoke weights (e.g., weights 506) and/or training data (e.g., training data 508) for third set of network topology parameters 516.

An example of third prompt set 514 and third set of network topology parameters 516 is shown below in Table 4:

TABLE 4

| Fourth Prompt Set 518 | Fourth Set of Network Topology Parameters 520 |
|---|---|
| Finally, create a detailed, | # Data Center Site |
| hierarchical list of named nodes | Router ‘dc-core-router1’ is the primary core router. |
| (plausible hostnames) that | ## Data Center Operations Department |
| includes all routers, switches, and | Switch ‘switch-dc-ops' is the network switch for the |
| devices listed above. | department. |
| Ensure each device is accounted | Devices desktop-dc-tech1’ through ‘desktop-dc-tech10’ are |
| for, including desktops, laptops, | desktops for technicians. |
| tablets, and other equipment for | Devices ‘laptop-dc-supervisor1’ through ‘laptop-dc- |
| each staff member. Use headers | supervisor4’ are laptops for supervisors. |
| to organize the list by department | Devices ‘voip-dc-ops1’ through ‘voip-dc-ops12’ are VoIP |
| or functional area. | phones. |
| | ## Network Engineering Department |
| | Switch ‘switch-net-eng’ is the network switch for the |
| | department. |
| | Devices ‘router-dc-border1’ and ‘router-dc-border2’ are |
| | border routers. |
| | Devices ‘switch-tor1’ through ‘switch-tor4’ are Top-of-Rack |
| | switches. |
| | Device ‘switch-oob-mgmt’ is the out-of-band management |
| | switch. |

### Formalization:

In some implementations, network topology generation process 10 may generate 304, using the machine learning model, a plurality of network nodes from a plurality of network schemas. For example, in the “formalization” actions of network topology generation process 10, machine learning model 400 takes sets of network topology parameters organized in a high-level outline as described above and generates a machine-readable representation of the network topology as a virtual network configuration file (e.g., a structured JSON representation). While the brainstorming outline generated from the plurality of network topology parameters is human-readable and editable, downstream applications (network simulators, visualization tools, analysis software) require structured data with guaranteed schema conformance.

In some implementations, machine learning model 400 generates a network topology in a top-down fashion using a breadth-first traversal strategy, starting from a designated root node and recursively creating subtrees and child nodes. In one example, the generation begins at the root (typically an organization's main router) and proceeds level by level: first generating all Site-level nodes, then all Department-level nodes within each Site, then Device Groups within each Department, and finally individual Devices within each Device Group.

In some implementations, the plurality of network schemas include one or more of: a first JSON schema defining network-wide characteristics; a second JSON schema defining network nodes with child relationships; and a third JSON schema defining terminal device specifications. For example, the first JSON schema may be a “Root Node” schema that defines the characteristics of the overall network and establishes foundational parameters that propagate throughout the topology. In some implementations, the root node may be a router device representing the entity's primary network gateway. In this example, key properties for the first JSON schema include:
Hierarchical level: The starting level (Enterprise, Site, or Department) indicates organizational scope-Enterprise implies a large organization with multiple sites, Site implies a single-location organization with multiple departments, and Department implies a small business or residential setting.
Network ecosystem: The model specifies an appropriate vendor ecosystem (e.g., Cisco, Fortinet, Juniper) based on organizational context, which informs device naming and configuration conventions throughout the topology.
Internet provider: A context-appropriate ISP is selected (e.g., Comcast for a US-based organization, NTT Communications for a Tokyo location), with corresponding realistic WAN addressing.
Hierarchy levels: An explicit list of the hierarchical levels that will be present in this network (e.g., [Enterprise, Site, Department, Device Group, Device] for a large organization, or [Department, Device Group, Device] for a small business).
Subnet configuration: CIDR blocks are allocated from appropriate private IP ranges—172.16.0.0/12 for Enterprise-level roots, 10.0.0.0/8 for Site-level roots—establishing the addressing scheme for all descendant nodes.
Device list: A comprehensive inventory of all devices in the organization, using compact notation (e.g., desktop-admin[1-5] represents five desktops).

An example of portions of the first JSON schema is shown below:

```
{
  “name”: “root_node”,
  “schema”: {
    “type”: “object”,
    “properties”:
      “root_node”:
        “type”: “object”,
        “properties”: {
          “name”: {
            “type”: “string”,
            “description”: “A Router named after the organization, e.g., ‘XYZ Corp.
Router’”
          },
            ...
```

In some implementations, the second JSON schema may be an “Intermediate Node” schema that defines the attributes and relationships of nodes that have child nodes-specifically, nodes at the Site, Department, or Device Group levels. In some implementations, machine learning model 400 may logically group child nodes under appropriate intermediate nodes based on their roles, relationships, and network requirements. In some implementations, the second JSON schema (e.g., the intermediate node schema) may include the following properties:
Node class assignment: Sites are represented by routers (providing inter-site routing), Departments are represented by switches (providing intra-department connectivity), and Device Groups are logical groups (representing functional groupings without dedicated hardware, such as “IoT Devices” or “Workstations”).
Subnet segmentation: The parent's CIDR block is subdivided into smaller blocks for child nodes, maintaining hierarchical addressing. VLAN assignments are tracked globally to prevent conflicts-when generating nodes, machine learning model 400 is informed of VLANs already in use and must select non-conflicting VLAN IDs.
Device distribution: The parent node's device list is partitioned among child nodes. For Department-level nodes, devices are typically distributed into 1-4 Device Groups based on device type-a common pattern groups IoT devices (which require network isolation), end-user workstations, and critical infrastructure separately.

An example of portions of the second JSON schema is shown below:

```
{
  “name”: “generate_inner_nodes”,
  “schema”: {
    “type”: “object”,
    “properties”: {
      “child_nodes”: {
        “type”: “array”,
        “items”: {
          “type”: “object”,
          “properties”: {
            “name”: { “type”: “string” },
            “level”: {
              “type”: “string”,
            . . .
```

In some implementations, the second JSON schema may be a “Leaf Node” schema that defines the attributes of terminal nodes that do not have any child nodes-specifically, individual devices. For example, each leaf node may represent an actual network endpoint with complete device specifications:
Device details: Including device class (router, switch, server, endpoint, etc.) and subclass (e.g., “VOIP Phone,” “Firewall Appliance,” “Database Server”).
Network identity: Unique IP address within the parent subnet, MAC address, hostname(s), and for telephony devices, phone numbers.
Operating system and applications: Platform-appropriate operating systems and software relevant to the device's function (e.g., a DNS server runs appropriate name resolution software).

An example of portion of the third JSON schema is shown below:

```
{
  “name”: “outer_nodes”,
  “schema”: {
    “type”: “object”,
    “properties”: {
      “child_nodes”: {
        “type”: “array”,
        “items”: {
          “type”: “object”,
          “properties”: {
            “name”: { “type”: “string” },
            . . .
```

In some implementations, network topology generation process 10 may generate 306 a virtual network configuration file based upon, at least in part, the input description, the plurality of network topology parameters, and the plurality of network nodes. For example, the schema design of the plurality of network nodes ensures that each node type (routers, switches, servers, endpoints, security appliances, IoT devices, etc.) has well-defined attributes and relationships. In some implementations, machine learning model 400 coalesces all generated nodes into a virtual network configuration file (e.g., a single JSON tree structure) representing the complete network topology, with the root node containing its child nodes, each of which contains its own children, recursively down to leaf device nodes. In one example, the virtual network configuration file as a hierarchical JSON representation can then be exported to various formats for visualization, simulation, or analysis.

In some implementations, generating 306 the virtual network configuration file includes mapping 308 the plurality of network topology parameters to respective network nodes from the plurality of network nodes; and generating 310 a hierarchical network topology using the plurality of network nodes. For example, network topology generation process 10 may generate 306 the virtual network configuration file by mapping 308 the plurality of network topology parameters to respective network nodes (e.g., defined by the first JSON schema, the second JSON schema, and/or the third JSON schema). For example, network topology generation process 10 may iteratively generate child nodes in breadth-first order by: for each node at a current hierarchical level, generating child nodes at the next lower level using a JSON schema appropriate for the node type; partitioning the parent node's device list among the generated child nodes; and tracking global state information associated with each of the one or more generated child network nodes including allocated network resources to prevent conflicts among the child network nodes. Network topology generation process 10 may generate 310 a hierarchical network topology using the plurality of network nodes by coalescing all generated nodes into a hierarchical data structure representing the complete network topology.

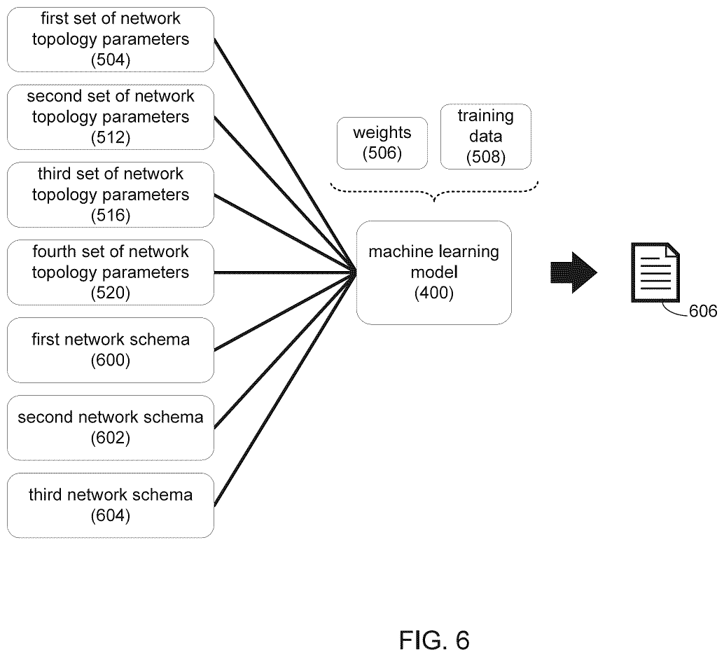

Referring also to FIG. 6 and in some implementations, network topology generation process 10 may generate 306 a virtual network configuration file by processing the input description (e.g., input description 500), the plurality of network topology parameters (e.g., first set of network topology parameters 504; second set of network topology parameters 512; third set of network topology parameters 516; fourth set of network topology parameters 520), and the plurality of network nodes generated from the plurality of network schemas (e.g., first network schema 600; second network schema 602; and third network schema 604) using machine learning model 400. As discussed above, machine learning model 400 may process particular weights (e.g., weights 506) and/or training data (e.g., training data 508) to generate the virtual network configuration file (e.g., virtual network configuration file 606).

An example of a portion of virtual network configuration file 606 is shown below:

```
{
  “name”: “XYZ Corp. Main Router”,
  “level”: “Site”,
  “node_type”: “Root”,
  “node_class”: “Router”,
  “characteristics”:
    “ecosystem”: “Cisco SMB”,
    “internet_provider”: “Comcast Business”,
    “hierarchy_levels”: [“Site”, “Department”, “Device Group”, “Device”]
  },
  “subnet”:
    “type”: “Standard”,
    “gateway”: “10.0.0.1”,
    “ip_address”: “10.0.0.1”.
    “cidr”: “10.0.0.0/16”
  },
```

### Simulation:

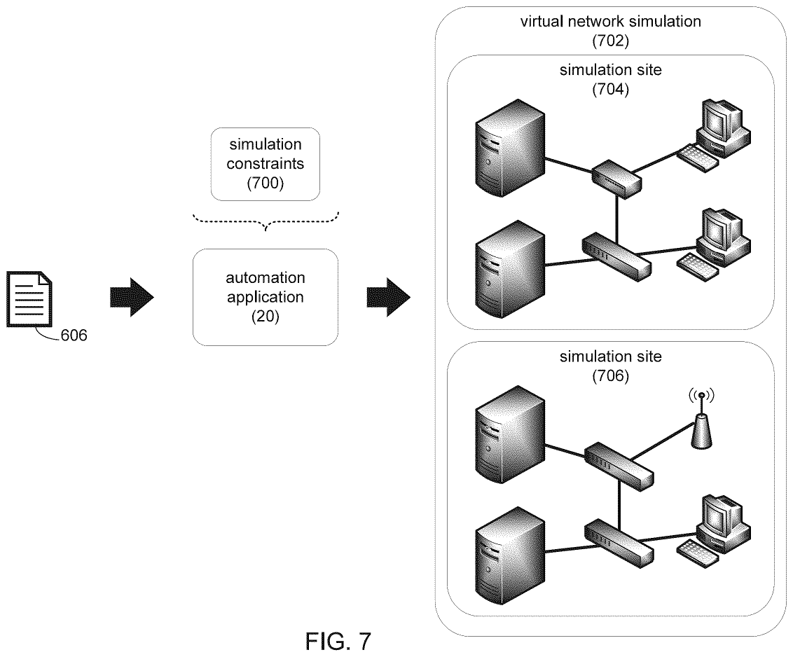

In some implementations, network topology generation process 10 may execute 312 a simulation of a virtual network using the virtual network configuration file. Referring also to FIG. 7 and in some implementations, network topology generation process 10 may process virtual network configuration file 606 using an application (e.g., automation application 20) to generate a virtual network representation from virtual network configuration file 606. For example, suppose a user generates virtual network configuration file 606 representative of a network deployed for an entity (e.g., XYZ Corp.). In this example, automation application 20 may be configured to perform a simulation of the virtual network using predefined simulation constraints (e.g., simulation constraints 700). In one example, simulation constraints 700 define the types of network traffic being processed by the virtual network, the applications being used by the devices within the virtual network, a scenario describing component failures, security attacks, the latency, bandwidth, packet sizes, and other communication information associated with the processing of data within the virtual network.

In the example of FIG. 7, network topology generation process 10 may execute 312 a simulation (e.g., virtual network simulation 702) using virtual network configuration file 606 based on simulation constraints 700. In this example, network topology generation process 10 executes 312 virtual network simulation 702 with two simulation sites (e.g., simulation sites 704, 706) where each simulation site has particular network infrastructure and devices. In this manner, network topology generation process 10 is able to generate an executable virtual network configuration file using network topology generation process 10 and an input description.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method, executed on a computing device, comprising:
processing, using a machine learning model, an input description of a target virtual network topology;
generating a plurality of network topology parameters using the input description by processing, on the machine learning model, a plurality of prompts defining the plurality of network topology parameters from the input description;
generating, using the machine learning model, a plurality of network nodes from a plurality of network schemas; and
generating a virtual network configuration file based upon, at least in part, the input description, the plurality of network topology parameters, and the plurality of network nodes.

2. The computer-implemented method of claim 1, wherein the machine learning model is a multimodal machine learning model.

3. The computer-implemented method of claim 2, wherein the input description includes one or more of a text-based description and an image-based description of the target virtual network topology.

4. The computer-implemented method of claim 1, wherein the plurality of network topology parameters include one or more of:
entity size information;
network infrastructure information; and
network device information.

5. The computer-implemented method of claim 1, wherein the plurality of network schemas include one or more of:
a first JSON schema defining network-wide characteristics;
a second JSON schema defining network nodes with child relationships; and
a third JSON schema defining terminal device specifications.

6. The computer-implemented method of claim 1, wherein generating the virtual network configuration file includes:
mapping the plurality of network topology parameters to respective network nodes from the plurality of network nodes; and
generating a hierarchical network topology using the plurality of network nodes.

7. The computer-implemented method of claim 1, further comprising:
executing a simulation of a virtual network using the virtual network configuration file.

8. A computer program product residing on a non-transitory computer readable storage medium having a plurality of instructions stored thereon which, when executed across one or more processors, causes at least a portion of the one or more processors to perform operations comprising:
processing, using a machine learning model, an input description of a target virtual network topology;
generating a plurality of network topology parameters using the input description by processing, on the machine learning model, a plurality of prompts defining the plurality of network topology parameters from the input description;
generating, using the machine learning model, a plurality of network nodes from a plurality of network schemas; and
generating a virtual network configuration file based upon, at least in part, the input description, the plurality of network topology parameters, and the plurality of network nodes.

9. The computer program product of claim 8, wherein the machine learning model is a multimodal machine learning model.

10. The computer program product of claim 9, wherein the input description includes one or more of a text-based description and an image-based description of the target virtual network topology.

11. The computer program product of claim 8, wherein the plurality of network topology parameters include one or more of:
entity size information;
network infrastructure information; and
network device information.

12. The computer program product of claim 8, wherein the plurality of network schemas include one or more of:
a first JSON schema defining network-wide characteristics;
a second JSON schema defining network nodes with child relationships; and
a third JSON schema defining terminal device specifications.

13. The computer program product of claim 8, wherein generating the virtual network configuration file includes:
mapping the plurality of network topology parameters to respective network nodes from the plurality of network nodes; and
generating a hierarchical network topology using the plurality of network nodes by:
generating, at each network node of a current hierarchical level, one or more child network nodes at a next lower level using a network schema associated with the network node;
partitioning a network device list from a parent network node among the one or more generated child network nodes; and
tracking global state information associated with each of the one or more generated child network nodes.

14. The computer program product of claim 8, wherein the operations further comprise:
executing a simulation of a virtual network using the virtual network configuration file.

15. A computing system including one or more processors and one or more memories configured to perform operations comprising:
processing, using a machine learning model, an input description of a target virtual network topology;
generating a plurality of network topology parameters using the input description by processing, on the machine learning model, a plurality of prompts defining the plurality of network topology parameters from the input description;
generating, using the machine learning model, a plurality of network nodes from a plurality of network schemas; and
generating a virtual network configuration file based upon, at least in part, the input description, the plurality of network topology parameters, and the plurality of network nodes.

16. The computing system of claim 15, wherein the machine learning model is a multimodal machine learning model.

17. The computing system of claim 16, wherein the input description includes one or more of a text-based description and an image-based description of the target virtual network topology.

18. The computing system of claim 15, wherein the plurality of network topology parameters include one or more of:
entity size information;
network infrastructure information; and
network device information.

19. The computing system of claim 15, wherein the plurality of network schemas include one or more of:
a first JSON schema defining network-wide characteristics;
a second JSON schema defining network nodes with child relationships; and
a third JSON schema defining terminal device specifications.

20. The computing system of claim 15, wherein generating the virtual network configuration file includes:
mapping the plurality of network topology parameters to respective network nodes from the plurality of network nodes; and
generating a hierarchical network topology using the plurality of network nodes by:
generating, at each network node of a current hierarchical level, one or more child network nodes at a next lower level using a network schema associated with the network node;
partitioning a network device list from a parent network node among the one or more generated child network nodes; and
tracking global state information associated with each of the one or more generated child network nodes.
